(19) United States
(12) Patent Application Publication
(10) Pub. No.: US 2005/0132558 A1
(43) Pub. Date: Jun. 23, 2005

(54) Method of treating a glazing panel

(76) Inventors: Denis John Hennessy, Ottawa (CA); Said Nayel, Nepean (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/918,346

(22) Filed: Aug. 16, 2004

Related U.S. Application Data
(60) Provisional application No. 60/529,882, filed on Dec. 17, 2003.
(60) Provisional application No. 60/547,421, filed on Feb. 26, 2004.

(51) Int. Cl. E06B 7/12; B23P 25/00

(52) U.S. Cl. 29/525; 29/458

(57) ABSTRACT

The present invention relates to a method of treating a glazing panel from an inside location. Moreover, the present invention relates to a method of treating glazing panels used in windows and patio doors. Initially, an orifice is formed on both the inside and outside panes on windows and on the side and outside frames of patio doors. Then, particulate matter such as dirt, dust, and mineral deposits are purged from the enclosed volume of the glazing panel by applying a cleaning solution via the orifice. Next, a valve is attached to the outside pane/frame to cover the orifice whereby the valve is designed to reduce the amount of precipitation or matter from entering while allowing air to exit the glazing panel. Finally, a seal is used to cover the orifice on the inside pane or side frame to ensure that the building air does not enter the interior of the glazing panel. The method can also be used to treat windows for high altitude transport, or to prevent explosion in the presence of intense heat.

### CROSS REFERENCE TO RELATED APPLICATIONS

This application claims the benefit of U.S. Provisional Application No 60/529,882, filed Dec. 17, 2003 and U.S. Provisional Application No 60/547,421 filed Feb. 26, 2004 which are incorporated herein by reference.

### FIELD OF THE INVENTION

The present invention relates to glazing panels and particularly to a method of treating a glazing panel. Moreover, the present invention relates to a method of treating glazing panels used in windows and patio doors.

### BACKGROUND

In multiple paned glazing panels condensation occurs when heat transferred through a glazing panel, via conduction, air leaks or radiation, causes the temperature of the inside air to become warmer than the temperature of its surrounding panes. The consequences of condensation include water vapor or fog forming on the inner surfaces of the glass panes resulting in an obstructed view when looking through the glass surfaces. Dirt, debris and/or mineral deposits may also collect between the panes on the inner surfaces. In addition, the wet inside surface may result in the growth of mold spores, leading to a potential health hazard.

When heat is transferred through a glazing panel, the layer of air enclosed by the panels may expand or contract resulting in the glass panes acting like a pump. In order to prevent the glazing panel from shattering, it is known in the art to provide tiny ventilation holes on the outside surface of the frame to allow air to enter and escape from the enclosed layer. These air holes may also allow particulate mailer from the outside air, such as dirt and dust, to enter the interior of the glazing panel. This particulate matter in combination with the accumulation of dissolved minerals from the water vapor formed during the process of condensation, may result in mineral deposits forming on the glazing panel.

One known method of solving the problem of condensation and/or debris on the inside surfaces of a glazing panel is replacement of the glazing panel. This is wasteful and costly.

Another method is described in Canadian Patent No. 1,332,541 to Collins, the disclosure of which is incorporated herein by reference. The method involves creating an orifice in one of the panes and applying a “filter means” thereto. The filter means is in the form of a patch having marginal regions attached to the pane and a medial membranous filter screen or mesh extending across the mouth of the orifice. One problem with this method is that in order to create an orifice in the outside pane, the pane must be drilled from the outside. This can be inconvenient and extremely difficult in certain glazing panels, such as those in high-rise buildings. In one embodiment of the Collins patent, a second orifice is created in the same pane. For cleaning, a solution is fed into one orifice and out the other. The second orifice, which is eventually covered by a filter means, is said to assist convection. However, having multiple orifices is not preferred, because the pressure buildup within the glazing panels may not be sufficient to permit egress of moisture.

Glazing panels using tempered glass panes such as panes in patio doors cannot be treated by creating an orifice in the glass. One of skill in the art will understand that drilling an orifice into tempered glass will cause the glazing panel to shatter. Replacement is currently the only one known method for treating patio door glazing panels which have condensation and/or debris on the inner surfaces thereof. Replacement is wasteful and costly.

A further problem encountered in the window industry is cracking or breakage of windows during transport, particularly at high altitudes such as by air freight or through mountainous regions. This problem is believed to be due to the difference in barometric pressure between the air trapped between the panes, and the outside air pressure. The window industry currently uses capillary tubes (small plastic tubes of approximately ¼″ diameter) inserted in holes drilled in the spacer between the window panes to equalize the pressure. When the windows reach their destination, the capillary tubes must be withdrawn or clipped flush with the outside surface of the spacer, and the remaining hole plugged. This is an expensive and labor intensive operation. Capillary tubes are also prone to becoming clogged or plugged with dirt, or bent and effectively sealed, both of which prevent their proper operation.

A further problem that is encountered with current sealed windows is their potential to explode when heated, such as when they are exposed to a fire in a building. Heating the windows causes an increased pressure inside the window unit and causes them to explode, posing a significant hazard to inhabitants and firefighters.

Accordingly, it is desirable to provide for a method of treatment for glazing panels which overcomes these problems.

### SUMMARY OF THE INVENTION

It is an object of the present invention to obviate or mitigate at least one of the problems of the prior art.

According to an aspect of the present invention there is provided a method of treating an installed glazing panel, the glazing panel having an inside pane, an outside pane and a spacer separating the panes, the method comprising the steps of: creating from an inside location an inside orifice in the inside pane; creating an outside orifice in the outside pane; installing a valve on the outside pane for reducing the ingress of precipitation or matter between the inside and outside panes while allowing air including moisture in the air to exit from between the inside and outside panes; and sealing the inside orifice.

The orifices may be created adjacent an upper edge of the respective panes. The outside orifice may be created by accessing the outside pane through the inside orifice. The valve may be adhered to the outside pane. The valve may be friction fit within the outside orifice. The orifices may be created by a method selected from the group consisting of drilling, cutting, laser cuffing, water cuffing, and drill press drilling. The inside orifice may be sealed by a seal selected from the group consisting of a plug made of glass, polyethylene, polyester, polycarbonate, acrylic, Lexan™ or Mylar™, a disc made of glass, polyethylene, polyester, polycarbonate, acrylic, Lexan™ or Mylar™, and silicone. The method may further comprises a step of, prior to sealing the inside orifice, applying a cleaning solution through the inside orifice and removing the cleaning solution thereby cleaning inside surfaces of the panes. The method may further comprising a step of, prior to applying the cleaning solution, creating a drain orifice in the inside pane for draining cleaning solution or applying cleaning solution. The drain orifice may be created adjacent a bottom of the inside pane. The method may further comprise the step of, prior to the sealing step, accelerating moisture egress by a technique selected from the group consisting of introducing an artificial light source to increase the temperature and thus the pressure within the glazing panel; pumping in heated air through any of the orifices; creating a vacuum by closing off all but one orifice and applying a vacuum to this orifice to draw moisture out; inserting via any one of the orifices, desiccants to absorb the moisture within the panels.

According to another aspect of the present invention there is provided a method of treating a glazing panel having a frame, first and second panes forming a cavity, and a spacer separating the panes, the method comprising the steps of: creating a vent orifice in a side of the frame the cavity and a location outside of the glazing panel passing through the spacer and inserting a vent tube in the vent orifice; creating a breather orifice in the frame between a location outside of the glazing panel and intersecting with the vent orifice and inserting a breather tube in the breather orifice in communication with the vent tube; applying a valve to the breather tube for reducing the amount of precipitation or matter from entering while allowing air including moisture in the air to exit from between the panes; and sealing the vent orifice.

The method of treating the glazing panel having a frame may further comprise the steps of: creating a drain orifice in the frame distinct from the vent and breather orifices between the space between the panes and a location outside of the glazing panel passing through the spacer for draining liquid from between the panes; and sealing the drain orifice. The valve may be adhered to the breather tube. The valve may be friction fit within the breather tube. The vent orifice may be sealed by a seal selected from the group consisting of a plug made of glass, polyethylene, polyester, polycarbonate, acrylic, Lexan™ or Mylar™, a disc made of glass, polyethylene, polyester, polycarbonate, acrylic, Lexan™ or Mylar™, and silicone. The method may further comprise a step of, prior to sealing the vent orifice, applying a cleaning solution through the vent orifice and removing the cleaning solution for cleaning inside surfaces of the panes. The vent orifice may be created adjacent a top of the glazing panel. The drain orifice may be created adjacent a bottom of the glazing panel. The method may further comprise the step of, prior to the sealing step, accelerating moisture egress by a technique selected from the group consisting of introducing an artificial light source to increase the temperature and thus the pressure within the glazing panel; pumping in heated air through any of the orifices; creating a vacuum by closing off all but one orifice and applying a vacuum to this orifice to draw moisture out; inserting via any one of the orifices, desiccants to absorb the moisture within the panels.

According to another aspect of the present invention there is provided a method of treating a glazing panel for protecting the panel from breakage from pressure change caused by fire or elevation changes, the method comprising the steps of: positioning the glazing panel for treatment; and creating an orifice in a pane of the glazing panel. The method may further comprise the step of installing a valve on the pane for reducing the amount of precipitation or matter from entering through the orifice in while allowing air including moisture in the air to exit the glazing panel.

In another aspect, the present invention provides a method of removing particulate matter such as dirt, dust and dissolved mineral deposits from, and/or preventing fogging of, a glazing panel, the glazing panel having at least two panes of glazing material and peripheral spacing means separating said panes, the method comprising: creating, from an inside location, an orifice in both inside and outside panes of the glazing panel; applying a cleaning solution to interior surfaces of the panes through the orifice in the inside pane; applying a valve with a filter membrane to the orifice in the outside pane to filter air passing therethrough; and sealing the orifice in the inside pane with a seal.

In another aspect, the present invention provides a method of preparing a glazing panel for high altitude transport employing the steps recited above. In another aspect, the present invention provides a method of preventing explosion of glazing panels in a fire or at high altitudes employing the steps recited above. In both the first and second aspects, the orifice can be created in an outside pane of the glazing panel.

### BRIEF DESCRIPTION OF DRAWINGS

Embodiments of the present invention will now be described, by way of example only, with reference to the attached Figures, wherein:

FIG. 1 illustrates a cross-section of a treated double glazing panel;

FIG. 2 illustrates a further cross-section of a treated double glazing panel;

FIGS. 3a and 3b illustrate methods of treating glazing panels according to the present invention;

FIG. 4 illustrates another method of treating glazing panels according to the present invention.

FIG. 5 illustrates a patio door with a double glazing panel for treatment;

FIG. 6 illustrates a cross sectional view of the patio door shown in FIG. 5;

FIG. 7 illustrates another patio door with a double glazing panel for treatment;

FIGS. 8a and 8b illustrate cross sectional views of the patio door shown in FIG. 7;

FIGS. 9a and 9b illustrate methods of treating patio doors with glazing panels according to the present invention; and

FIG. 10 illustrates another method of treating patio doors with glazing panels according to the present invention.

FIG. 11 illustrates a valve in place on a glazing panel according to the present invention.

FIG. 12 illustrates a valve in place on a glazing panel according to the present invention.

FIGS. 13a,b and c illustrate a valve in place on a glazing panel according to the present invention and a valve in isolation.

FIGS. 14a,b and c illustrate a valve in place on a glazing panel according to the present invention and a valve in isolation.

### DETAILED DESCRIPTION

Generally, the present invention relates to methods of treatment for panels such as multiple-glazed panels. Double glazed panels are most common and their treatment will be primarily exemplified in the description of presently preferred embodiments. The manner in which triple glazed panels are treated is also discussed below. By treatment we refer to the partial or complete removal of particulate matter such as dirt, dust, and mineral deposits between, or adhering to the inside surfaces of double-glazed panels, and/or removing and/or preventing condensation or fogging between the panes.

The method employed differs depending on whether the glazing panel is tempered or non-tempered. For non-tempered glass, the glass itself is penetrated to allow access to the space between the panels. For tempered glass, which will shatter if drilled, the frame is penetrated to allow access to the space between the panels.

Double-glazed non-tempered panels come in various forms. The frame may be made of, for instance, wood, vinyl, aluminim, or fiberglass. The frame is not particularly relevant in this case as the panel itself is penetrated. Examples of non-tempered glass include soda-lime glass, sheet glass, polished plate glass, low-emissivity glass, reflective glass and heat-absorbing glass. Other than glass, glazing panels can be made of, for example, polycarbonates, polyesters, acrylics, Lexan™ and Mylar™. Non-tempered glass is commonly used in homes and buildings. Tempered glass is used for example in patio doors where strength is more important.

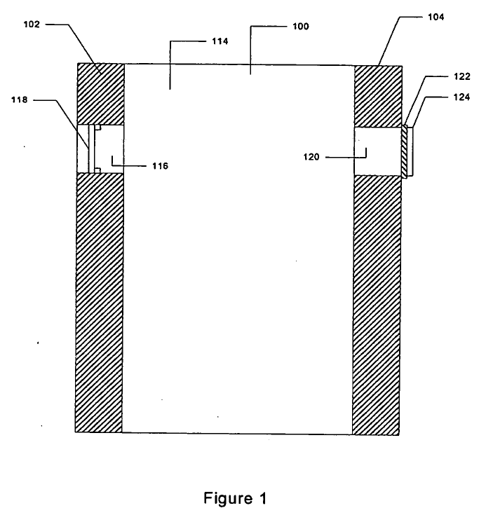

According to the embodiment shown in FIG. 1, a glazing panel 100 treated according to the present invention includes an outside glazing pane 102, inside glazing pane 104, separated by a spacer, such as a conventional peripheral spacer (not shown) and enclosing a layer of air 114. An inside orifice or hole 120 is created in the inside pane. Next, through the inside orifice 120, an outside orifice 116 is created in the outside pane. To create an orifice in a glass pane, techniques in the art may be used. Such techniques include but are not limited to drilling, cutting, laser cutting, water cutting. Both the inside and outside orifices are preferably near the top of the panel.

When drilling an orifice, a template may be used. A template can be a plastic sheet which is placed against the surface to be drilled and can stick to the surface with the aid of water. The template has different size holes near the corners such that when the template is placed flush in a corner, the holes align with a desired drilling area. The template also serves to protect the surrounding pane from glass shavings which may otherwise stick to the pane. When drilling, water or a solution can be sprayed on the drill bit and the surrounding area to prolong the life of the bit and to remove glass shavings from the cutting surface to allow the bit to create a cleaner hole and to reduce heat buildup on the glass surface. The drilling area can also be sprayed before drilling is started. To drill an orifice in a double pane, a rotary tool such as a Dremel™ rotary tool can be used with a drill bit. The orifices may be any shape, but will generally be round. To drill a wedge shaped notch, the rotary tool can be placed at an angle, for instance 45 degrees from the surface of the pane, and drilling continued using the outer edge of the drill bit until the drill bit is flush with the glass. The drill bit can be steadily moved to be perpendicular to the glass surface so that the flat end of the drill bit cuts straight into the orifice. The initial angle drilling is useful in controlling the orifice size and prevents wandering of the drill bit. The drill bit can be frequently moved away from the orifice enough to spray the area to remove glass shavings. The orifice can be sculpted by rotating the drill bit in small circles. The drilling is stopped once the bit penetrates the pane. In certain situations, a technician can reach around a glazing panel and perform similar drilling techniques. This can be useful to reach outside panes from an inside location. In this technique, a water rotary tool connected to a solution or water container can be used.

As an alternative to manual drilling of orifices, a drill press framework may be used which is known in the art to create orifices of glazing panels which are horizontal, such as during manufacture. Whereas during manual drilling the drill bit is preferably first placed against the glass at an angle and then moved to perpendicular to the pane, the drill press framework technique could use round, pointed, hollow or orbital bits to drill straight on. Concerns of controlling the orifice size and shape would be reduced in the drill press framework arrangement due to the nature thereof.

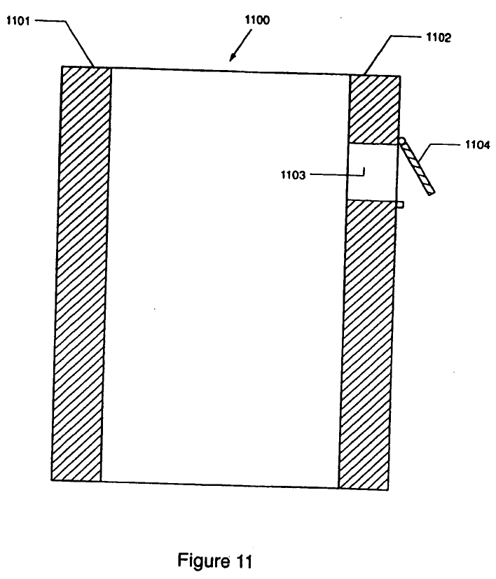

To the outside orifice 116, a valve 118 is applied. The general purpose of the valve is to limit moisture and debris from entering and to allow moisture to exit. FIGS. 11 to 14 illustrate various embodiments of valves. FIG. 11 shows a glazing panel 1100 with an inside pane 1101, an outside pane 1102 and an orifice 1103. Valve 1104 is hinged near the top of the orifice and tightly closes the orifice unless pressure is being exerted to open it from within the panel. Such pressure can be caused by an increased temperature between the panes caused by sunlight.

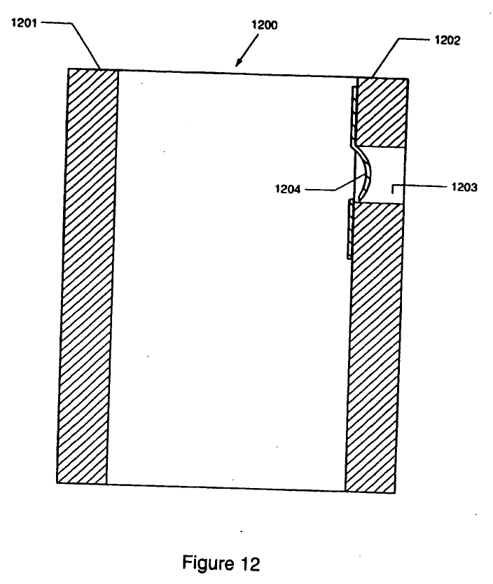

FIG. 12 shows a glazing panel 1200 with an inside pane 1201, an outside pane 1202 and an orifice 1203. Valve 1204 is adhered to the inner surface of the outer pane and has a flap which is opened or creates a larger opening under the influence of pressure from within the panel.

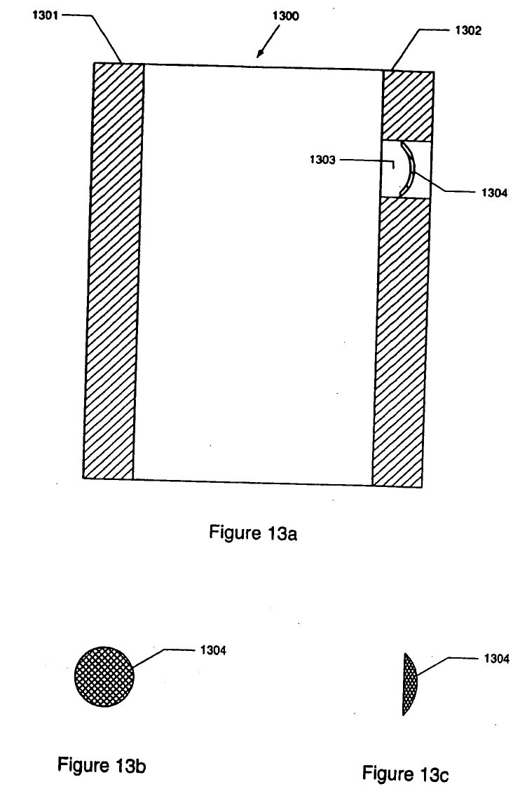

FIG. 13a shows a glazing panel 1300 with an inside pane 1301, an outside pane 1302 and an orifice 1303. Valve 1304 is friction fit within the orifice of the outside pane. FIGS. 13b and c show the valve 1304 in isolation. The valve is a mesh, for instance SS 430, 80 or 100 mesh. A stainless steel mesh with 10,000 holes per square inch has been found to be suitable since it will pass moisture laden air at elevated temperatures when the air layer is vented to the exterior, but will inhibit the ingress of moisture at lower temperatures, preventing the formation of condensation within the panel. It is envisaged, however, that the number of holes per square inch could be anywhere in the range 6,000 to 20,000. In any event, the mesh holes should be large enough to allow water vapor between the panes to exit but small enough to prevent atomized water (such as that of a pressurized cleaning sprayer) from entering. The screen can be rounded at its edges. In this way, the screen is more easily pressed into a friction fit within the orifice 1303 of the outside pane because of the greater surface area at its edges. To apply a valve of the type comprising a mesh, the surface is cleaned as described above. The concave portion of the mesh can be set against a magnetic end of a micro screen applicator. The mesh can be guided through an inner pane and placed into an outer pane orifice and held by friction fit. The applicator is then withdrawn. This method is used when treating from an inside location, however, the screen can be applied in other circumstances by varying this method. Since the screen does not protrude from the outside pane, damage thereto by cleaning or otherwise is mitigated.

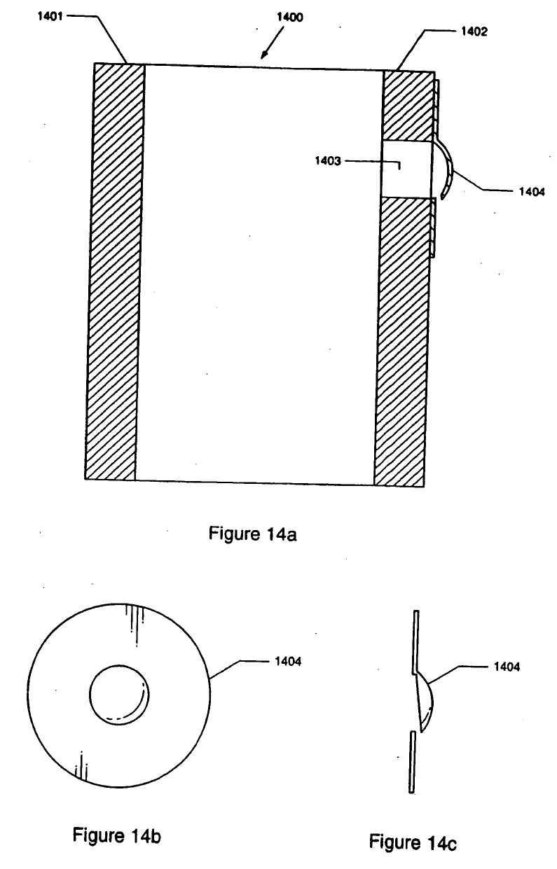

FIG. 14 shows a glazing panel 1400 with an inside pane 1401, an outside pane 1402 and an orifice 1403. Valve 1404 is adhered to the outer surface of the outer pane and has a flap which is opened or creates a larger opening under the influence of pressure from within the panel. FIGS. 14b and c show the valve 1404 in isolation.

In one embodiment, as illustrated in FIGS. 11, 12, 14a, 14b and 14c, the valve 1404 comprises a flap. The flap is partially open, closed or at least mostly closed until pressure between the panes forces the flap open thus allowing air and water vapour to escape. Once the pressure balances, the flap returns to its original position. One suitable valve is made of polyethylene, has a flexible flap and is hinged at the top so that when open, precipitation and debris is less likely to enter. In one embodiment, the closed position of the valve forms a fluid tight seal. In this way, stresses on the glazing panel caused by wind do not cause unacceptable distribution of stresses, namely stress points. The valve attaches to an area surrounding the orifice, or within the orifice. For instance, the valve may be suitably configured to elastically deform for placement within the orifice or may have an adhering perimeter for adhering to the pane. The valve can be adhered to the inside surface of the outside pane as illustrated in FIG. 12, and therefore the valve does not protrude from the outside pane and damage thereto by cleaning or otherwise is mitigated. The valve may be alternatively applied to the outside surface of the outside pane as illustrated in FIGS. 11 and 14a.

To apply a valve of the type which adheres to the surface of the pane, the area around the pane is preferably cleaned, as described above in relation to the valve. A valve applicator having a handle and a flat end can be inserted into the center of the valve and a backing on the valve can be peeled off to expose the adhesive surface. The valve applicator is used to apply the valve over the orifice with the opening facing down. Once in place, the applicator can be removed and using the other end of the applicator or other means, the outer edges of the valve are pressed against the pane.

Referring back to FIG. 1, in addition to the valve, the inside orifice 120 is sealed to ensure that the building air does not enter the glazing panel. In one embodiment, the seal 124 is made of polyethylene and has an adhesive 122 on one side. Alternatively, a suitable plug, silicon sealant or other suitable means of sealing can be used to seal orifice 120.

To apply a seal, the area around the orifice is preferably cleaned as described above in relation to the valve. The seal is held between one's fingers, a backing is removed to expose the adhesive, and the seal is applied over the orifice. Once in place, using the other end of the applicator or other means, the outer edges of the valve are pressed against the pane.

The size of the orifices created is not particularly limited by a minimum or maximum. Certain factors may be considered in deciding upon an orifice size. The outside orifice should be large enough to allow air to exit therethrough sufficiently to accomplish the purpose of the outside orifice. Therefore, the volume between the panes and the humidity of the environment may be considered. One may decide to have an outside orifice which is not much larger than the conditions require for aesthetic or other reasons. If desired, the diameter of the orifice may be kept to no larger than the thickness of the pane. That is, in one embodiment, for thicknesses of panes of 2 mm, 12 mm or 22 mm, the diameters of the orifices should be no greater than 2 mm, 12 mm or 22 mm respectively. These examples are intended to be illustrative rather than limiting.

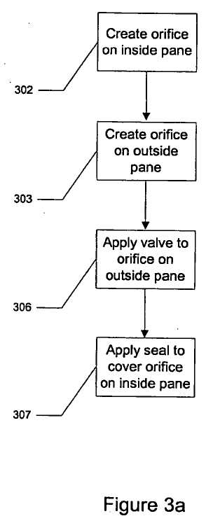

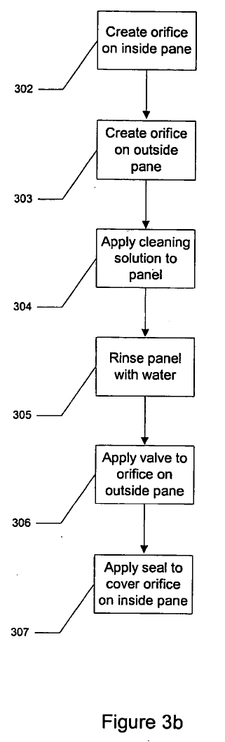

Referring to FIG. 3a, a method of treating glazing panels is illustrated. The glazing panel of FIG. 1 is used as a reference. An inside orifice 120 is created (302) in the inside glazing pane 104. Through the inside orifice 120, an outside orifice 116 is created (303) on the outside glazing pane 102. A valve 118 is then applied (306) to the outside glazing pane 102 as described above. A seal 124 is applied (307) over the inside orifice 120 to ensure that the building air does not enter the interior of the glazing panel.

Referring to FIG. 3b, another method of treating glazing panels is illustrated where the interior surfaces of the panes are cleaned prior to applying the seal. The glazing panel of FIG. 1 is used as a reference. An inside orifice 120 is created (302) in the inside glazing pane 104. Through this inside orifice 104, an outside orifice 116 is created (303) on the outside glazing pane 102. The inside of the panes are cleaned (304) and rinsed (305) by spraying a solution or water through the inside orifice 120. The solutions are drained through an orifice. A valve 118 is then applied (306) to the outside glazing pane 118 as described above. A seal 124 is applied (307) to cover the inside orifice 120 to ensure that the building air does not enter the interior of the glazing panel.

Water and/or cleaning solutions can be sprayed to clean and/or rinse panes. Depending on the condition of a pane, cleaning, rinsing and/or drying solutions or water can be used as desired. Prior to treatment, the glazing panel should be inspected to determine the best treatment approach. Visually, one can observe the degree of moisture, dirt and debris. One can also visually observe, corrosion on a pane which contains pits causing the pane to be somewhat opaque. The treatments of the present invention are not intended to treat corrosion, however, both corrosion and surface defects such as moisture or debris may be present together. In this case, the panel may be treated to improve the clarity thereof but the corrosion will remain. To determine the best solution(s) to use, spot testing may be employed. A spot test consists of applying solution to a small area of the pane and observing the efficacy of the solution. This may be accomplished with, for instance, a Q-Tip™. The material of the glazing panel may also be considered when selecting treatment particulars.

While moisture may not be present on a glazing panel, the panel may be near a point of condensation. To test whether this is the case, the panel is supercooled at which point, condensation may occur. If condensation occurs, it may be said that the panel is near failure and treatment may be desirable. One way to supercool an area of a panel is to place an icecube against the panel. Of course, even panels which are not near failure can be treated as a preventative measure and/or to remove dirt or debris.

Cleaning, rinsing and drying solutions can be found in the art of glazing panel washing. However, for specific illustration, the following non-limiting examples are provided. Cleaning and rinse solutions include a) steam distilled water and deionized water; b) vinnegar or acetic acid with water in concentrations such as 50/50 and 25/75 in favour of water. In a presently preferred embodiment, a cleaning and rinsing solution is used from a) and/or b). Drying solutions include non-diluted methyl hydrate and isopropynol. For the drying solution, quick bursts of spray can be useful.

Draining of water or solutions can be achieved using a main drain tube and a micro drain tube. For large windows, more than one drain orifice may be useful. A drain tube is adapted to fit within an orifice in the pane and can be attached to a drain initiator such as a syringe or the like for initiating fluid flow from the end of the tube opposite the end within the panes. Once initiated, the drain initiator is removed and fluid is allowed to flow into a reservoir. The main drain tube is of a larger diameter than the micro drain tube and is used before the micro drain tube. The drain tube can also be connected to a wet/dry vacuum.

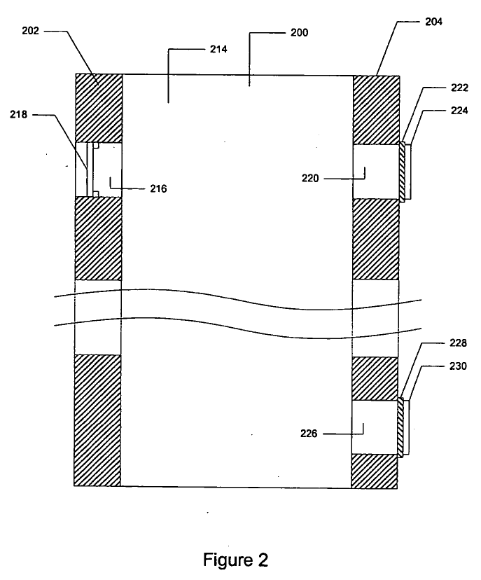

An alternate embodiment is illustrated in FIG. 2. The glazing panel 200 comprises outside and inside glazing panes 202, 204 respectively, separated by a spacer means such as a conventional peripheral spacer (not shown), enclosing a layer of air 214, with inside orifice 220, outside orifice 216, valve 218, seal 224 and adhesive film 222. This glazing panel 200 differs from the glazing panel 100 of FIG. 1, in that an additional orifice 226 is formed in proximity to the bottom edge of the inside glazing pane 204. In addition, a seal 230 is bonded by a film of adhesive 228 to cover the additional orifice 226 on the inside glazing pane 204, to ensure that the building air does not enter the glazing panel. This additional orifice 226 assists in cleaning between the panes as discussed below.

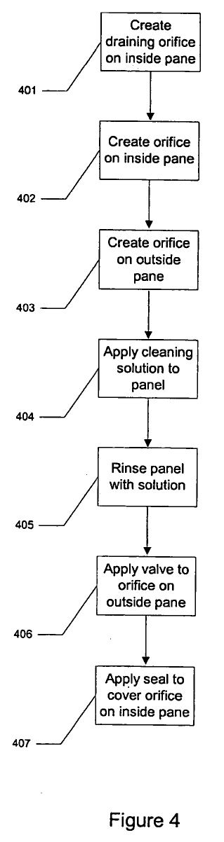

An alternate method of treating glazing panels is illustrated in FIG. 4. The glazing panel of FIG. 2 is used as a reference. Steps 402, 403, 404, 405, 406 and 407 are respectively the same as steps 302, 303, 304, 305, 306 and 307 described above with reference to FIG. 3b. This method differs from that described with reference to FIG. 3b by including an additional step 401 of creating an additional orifice 226 in the inside glazing pane 204, preferably near the bottom. In a presently preferred method, the additional orifice 226 in the inside glazing pane 204 is formed approximately 2.5 cm from an edge of the glazing panel, on the corner opposite of the inside orifice 220. This method also differs from the one shown in FIG. 3b in that the additional orifice 226 is provided as a dedicated draining means to drain both the cleaning solution used in step 404 and rinsing solution used in step 405. The additional orifice 226 can be created 401 at the lower of the two bottom corners for improved draining. Initially, an area of the inside glazing pane where the additional orifice 226 is to be created is sprayed with water or a solution to remove dust and to prevent shavings from socking to it. The inside pane 204 is penetrated and the inside of the panes is sprayed via the additional orifice 226. The additional orifice 226 is made large enough to insert the spray nozzle, which is then used to clean around the additional orifice 226 to remove glass particles. The bottom of the window is sprayed to form a coating which acts as a barrier of solution over the silica pellets. The area to be drilled in the top of the inside pane 204 is sprayed via the additional orifice 226. An inside orifice 220 is then created (402), preferably near a top corner, in the same manner as the additional orifice 226. This inside orifice 220 may need to be larger than the additional orifice 226 to allow creation of an outside orifice 216 in the outside pane 202. Through the inside orifice 220, the inside pane area around the inside orifice 220 is sprayed and the glass shavings are sprayed down to the bottom of the panel 200. A magnet set may be used to assist in removing the glass particles. A drain tube is set up through the additional orifice 226. Using a rotary water tool with a cleaning solution, an outer orifice 216 is drilled (403) in the outer pane 202 by inserting the drill through the inner orifice 220. When forming the outer orifice 216, the drilling device is preferably positioned at a downwards angle such that the outer orifice 216 is formed slightly below the inside orifice 220. Drilling is stopped once the pane is penetrated. Using a cleaning solution, the inside panes are sprayed (404) ensuring that glass shavings and whitish marks caused by drilling are removed. Once cleaned, the cleaning solutions are drained and/or are allowed to evaporate. The cleaning solution is preferably applied by an air compressor unit at pressures sufficient for the cleaning solution to reach all areas of the pane surfaces. A variable trigger may be used. After, a rinsing solution is applied 405 in the same manner as the cleaning solution to rinse the interior of the glazing panel. A valve 216 is applied (406) to the outside orifice 216. By the foregoing treatment, condensation between the window panes will slowly dissipate, typically over a period of one to three weeks, as the window is exposed to sunlight. The end result is a glazing panel free (or reduced) from particulate matter and condensation between the panes. The orifices in the inside pane are sealed as described above.

When treating a triple pane window an orifice is created in the outside pane. A water rotary tool with an orbital bit can be used. The tool can be attached to a solution or water container for spraying. Next, the area on the inside pane can be sprayed and then drilled. The inner orifice can be drilled straight on relative to the outer orifice to allow a spray nozzle to access the inner orifice and to ensure that the spray during drilling reaches the entire drilling area. Again, the area is sprayed during drilling.

A method of treating glazing panels from the outside is also provided. In one embodiment two orifices are created in the outside pane. One orifice is a valve orifice and is created near the top of the pane, preferably near a top corner. The other orifice is created near the bottom of the pane, preferably near the opposite bottom corner. The panel can now be cleaned by spraying cleaning solution or water through first the bottom orifice and then the top orifice and drained. Spraying through different orifices assists the cleaning. A valve of the type which adheres to the outside surface of the outside pane is suitable for application to the top orifice and a seal as described above is applied to the bottom orifice. It is preferred that the bottom orifice be created at the lower end of the pane for improved draining.

In the above embodiments, it is preferred to have only one valve. The single valve is preferably applied to an orifice in the upper portion of the outside pane and near the top. Further orifices may be created to assist cleaning and/or draining and/or drilling but these orifices should then be sealed. For instance, an orifice can be created near each bottom corner and each sealed after treatment. These methods can be used on panels which are not installed, i.e. which have not yet been installed or which have been taken down.

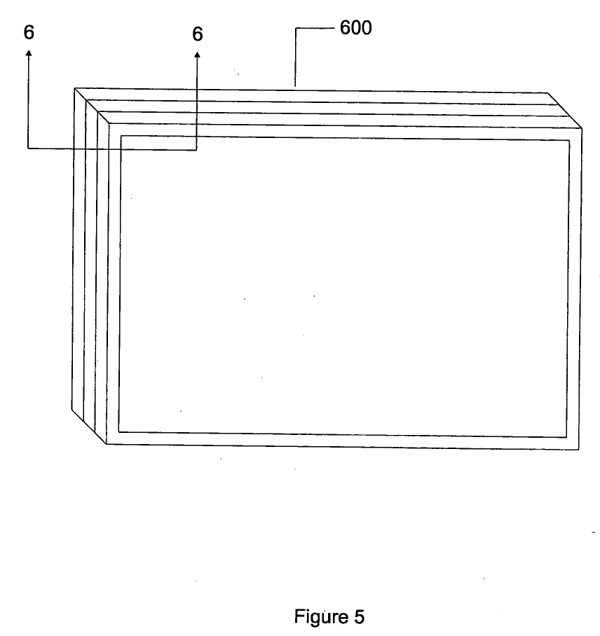

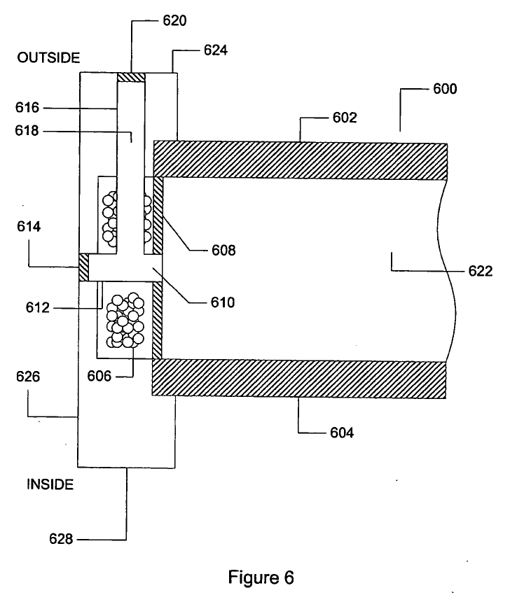

Another embodiment of the present invention is illustrated in FIG. 6. FIG. 6 is a cross-sectional view, along line 6 shown in FIG. 5, of a glazing panel used in a patio door 600. Although a patio door is used for example, the method could also be used for treating other glazing panels having tempered glass panes. In this method, orifices are created in the frame rather than in the pane because tempered glass will shatter if drilled. The glazing panel includes an outside glazing pane 602, inside glazing pane 604, separated by a peripheral spacer 608, containing silica pellets 606, and enclosing a layer of air 622. The edges of the glazing panes are connected to an outer frame 624, inner frame 628, and side frame 626. A vent orifice 610, having a vent tube 612 therein is formed from the side frame 626 and a breather orifice 618, having a breather tube 616 therein is formed from the outside frame 624 such that it intersects the vent orifice 610.

A valve 620 extends across the mouth of the breather orifice 618, allowing for the circulation of air between the enclosed layer of air 622 and the outside air. The valve may be similar to the valves described above. The valve for use in this embodiment will be particularly configured to cooperate with the breather orifice. In addition, a seal 614 such as a polyethylene disc, caulking and/or silicone is used to cover the vent orifice 610 to ensure that the building air does not enter the glazing panel.

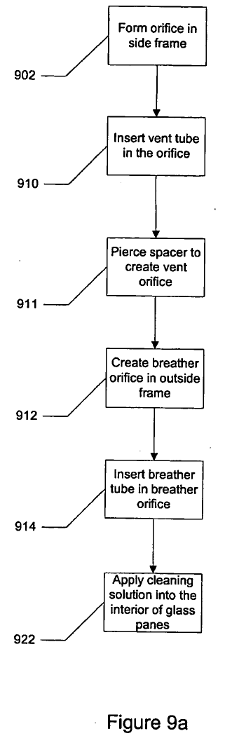

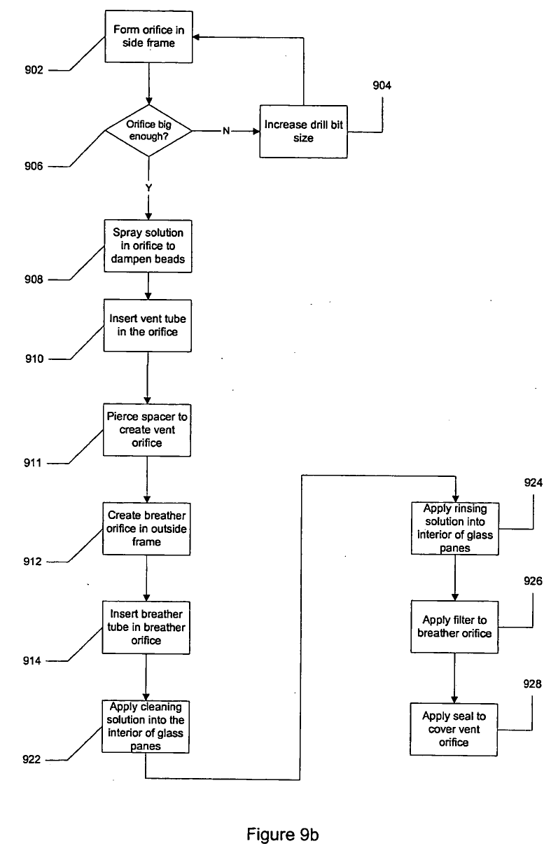

Referring to FIG. 9a, a method of treating glazing panels used in patio doors or the like is illustrated. The glazing panel of FIG. 6 will be used as a reference. An orifice which will become vent orifice 610 is created (902) in the side frame 626, a vent tube 612 is installed (910) in the orifice and the spacer 608 is pierced (911) to create a vent orifice 610. A breather orifice 618 is created (912) in the outside frame 624 and a breather tube 616 is inserted (914) in the breather orifice 618. A cleaning solution is applied (922) into the interior of the panes and the cleaning solution is removed or permitted to evaporate or drain.

Referring to FIG. 9b, another method of treatment of glazing panels used in patio doors is illustrated. The glazing panel of FIG. 6 will be used as a reference. Initially, the side frame 626 is drilled (902), preferably about 10 cm from the top of the glazing pane or 5 cm from where the glass meets the frame, using a drilling device such as a standard drill, to create (902) an orifice which will become vent orifice 610. Techniques other than drilling known in the art may be used depending on the frame material. While drilling, the shavings from the bit are constantly removed and the drilling is stopped prior to penetrating the spacer 608 between the panes.

This drilling process is repeated, each time using a slightly larger drill bit (904). Next, the drilling device is removed from the orifice and a solution is sprayed (908) into the orifice to dampen the pellets which are within the frame. A spray rod may be used to this end until a vent tube 612 can be inserted into the orifice. Once the orifice is large enough for a vent tube (made for instance of Teflon™), the vent tube 612 in inserted (910) until it meets flush with the inside of the spacer bar, and the drilling device is re-inserted into the orifice through the vent tube 612 and is used to drill through the pellets and the spacer 608 to form an opening with the enclosed layer of air, creating 911 a vent orifice 610 with a diameter of, for instance, approximately 5 mm.

The drilling device is then moved to the outside frame in proximity to the same vertical position as the vent orifice 610, for instance, 2 cm from the glass surface and is used to create (912) a breather orifice 618, with a diameter of, for instance, approximately 5 mm, to intersect and communicate with the vent tube 612. To assist accurate drilling, a drill bit or other object can be inserted into the vent orifice 610 so that when drilling the breather orifice 618 it will be known when the intersection of the two orifices occurs. Next, a breather tube 616 is inserted (914) into the breather orifice 618.

A cleaning solution can then be applied (922) into the glazing panel, preferably at a pressure sufficient to permit the cleaning solution to clean all areas of the pane surfaces, via the vent orifice 610 and subsequently drained or permitted to evaporate. After, a rinsing solution, if required, is applied in the same manner as the cleaning solution to rinse (924) the interior of the glazed panel, as described above. Finally, a valve 620 as described above, is applied (926) to the breather orifice 618 and a seal 614 is applied (928) to seal the vent orifice 610. The end result is a glazing panel with particulate matter and condensation reduced or removed from the inner surfaces of the glazing panel.

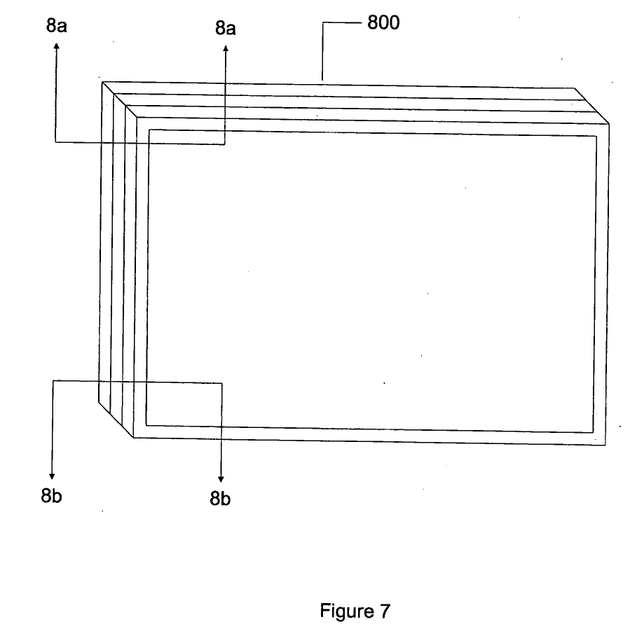

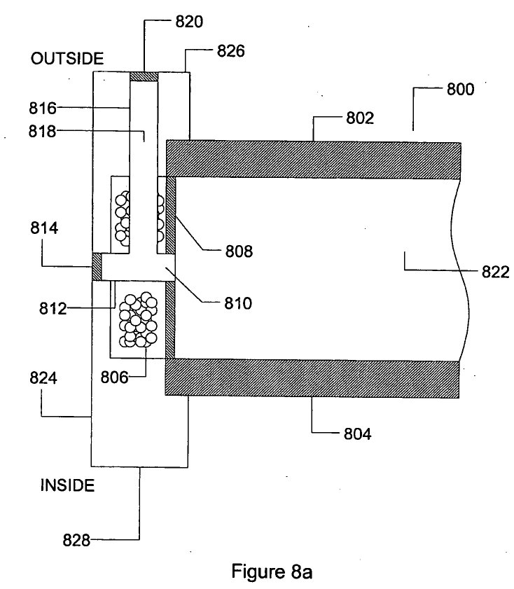

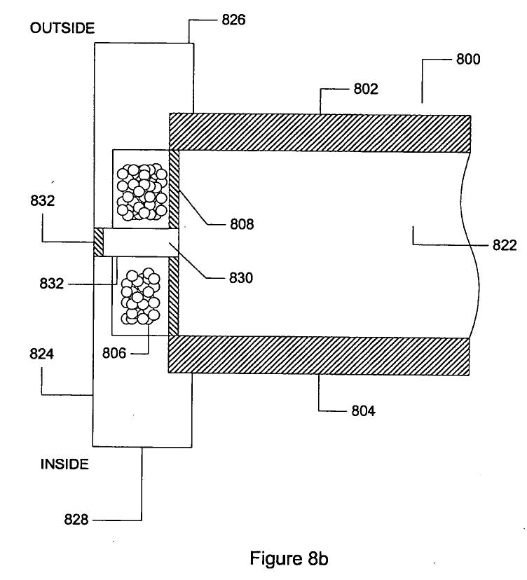

An alternate embodiment is illustrated in FIGS. 8a and 8b. FIG. 8a is a cross-sectional view, along line 8a shown in FIG. 7, of a glazing panel used in a patio door 800. Similarly, FIG. 8b is a cross-sectional view along line 8b of the same patio door. The glazing panel 800 comprises outside and inside glazing panes 802 and 804 respectively, separated by a conventional peripheral spacer 808, enclosing an inner layer of air 822. The glazing panel 800 also comprises silica pellets 806, a vent orifice 810 having a vent tube 812 therein covered by a seal 814, and a breather orifice 818 having a breather tube 816 therein with a valve 820 at the outer edge. The edges of glazing panel 800 are connected to an inner frame 828, outer frame 826 and side frame 824. This glazing panel 800 differs from the glazing panel 800 of FIG. 6, in that a draining orifice 830 is formed in the side frame 824, in proximity to the bottom edge of glazing panel 800. In addition, a seal 832 such as a polyethylene disc, silicone and/or caulking is used to cover the draining orifice 830 of glazing panel 800, to ensure that the air from the building or outdoors does not enter the glazing panel, after cleaning.

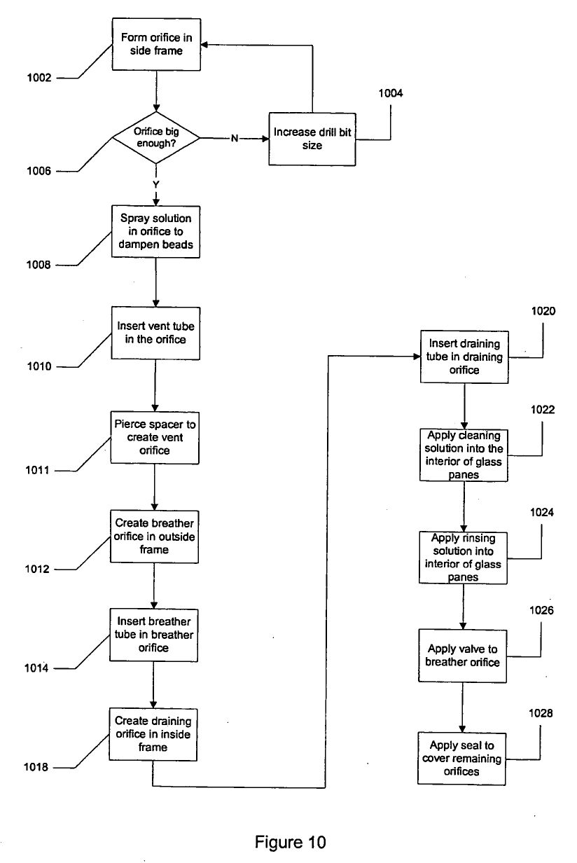

An alternate method of treatment for glazing panels used in patio doors is illustrated in FIG. 10. The glazing panel of FIGS. 8a and 8b will be used for reference. This method comprises steps 1002, 1004, 1006, 1008, 1010, 1011, 1012, 1014, 1022, 1024, 1026 and 1028 which are respectively equivalent to steps 902, 904, 906, 908, 910, 911, 912, 914, 922, 924, 926 and 928 of FIG. 9b. However, additional steps 1018 and 1020 are provided to create a draining orifice 830 with a diameter of, for instance, approximately 5 mm, the draining orifice 830 having a draining tube 832. In a presently preferred method, the drain orifice 830 is formed, for instance, approximately 5 cm from the bottom of the glazing panel. This method also differs from the one shown in FIG. 9b in that the draining orifice 830 is provided as a dedicated draining means to drain both the cleaning solution used in step 1022 and rinsing solution used in step 1024. Therefore, referring to FIG. 10, the side frame 824 is drilled (1002), for instance, about 10 cm from the top of the glazing pane or 5 cm from where the glass meets the frame using a drilling device such as a standard drill, to create an orifice which will become vent orifice 810. While drilling, the shavings from the bit are constantly removed and the drilling is stopped prior to penetrating the seal between the panes.

This drilling process is repeated, each time using a slightly larger drill bit (1004), until (1006) a vent tube 812 can be inserted (1010) into the orifice. The drilling device is removed from the orifice and a solution is sprayed (1008) into the orifice to dampen the pellets which are within the frame. A spray rod may be used to this end. Once the orifice is large enough for a vent tube 812 (made for instance of Teflon™), the vent tube 612 in inserted (1010) until it meets flush with the inside of the spacer bar, and the drilling device is re-inserted into the orifice through the vent tube 812 and is used to drill through the pellets and the spacer bar to form an opening with the enclosed layer of air, creating (1011) a vent orifice 810 with a diameter of, for instance, approximately 5 mm.

The drilling device is then moved to the outside frame in proximity to the same vertical position as the vent orifice 810, for instance, preferably 2 cm from the glass surface and is used to create (1012) a breather orifice 818, with a diameter of, for instance, approximately 5 mm, to intersect and communicate with the vent tube 812. To assist accurate drilling, a drill bit or other object can be inserted into the vent orifice 810 so that when drilling the breather orifice 818 it will be known when the intersection of the two orifices occurs. Next, a breather tube 816 is inserted (1014) into the breather orifice 818. Next, a draining orifice 830 is created (1018) in the side frame, preferably near the bottom of the panel and a draining tube 832 is inserted (1020) into the draining orifice 830.

A cleaning solution can then be applied (1022) into the glazing panel, preferably at high pressure, via the vent orifice 810 and subsequently drained or permitted to evaporate. After, a rinsing solution, if required, is applied in the same manner as the cleaning solution to rinse (1024) the interior of the glazed panel, as described above. A valve 820 of one of the types described above, is applied 1026 to the breather orifice 818 and a seal 814 is applied (1028) to seal the vent orifice 810. The end result is a glazing panel with reduced or removed particulate matter and condensation.

The draining tube is operated as described above using a drain initiator. A spray rod can be inserted through the vent orifice to spray the interior of the panes. A spray wand with two openings can be used to spray both panes. The rod may be slid from side to side.

For patio doors where the fixed portion is the outer pane, the cross ventilation occurs on the fixed slider portion. If the slider portion is the outer pane, the cross ventilation, in some cases, occurs on the fixed slider portion. When the slider is on the outside of the house, the outer pane and the weather stripping should be removed. Further orifices can be created, but preferably only one valve is used and therefore all remaining orifices should be sealed.

Thus the present invention provides a method of installing treatment orifices in glazing panels used in patio doors.

As will be appreciated by those of skill in the art, the present invention also provides a method and system for preventing cracking and breakage of window units during air transport or in mountainous regions. The orifice and valve of the present invention permit the air pressure inside and outside the window to equalize during such transport, thus obviating the need to use capillary tubes, with their attendant disadvantages. The orifice can be formed in any of the inside or outside panes, or in the spacer.

In order to accelerate the egress of moisture within the panels the following techniques may be used: introducing an artificial light source such as halogen lighting to increase the temperature and thus the pressure within the glazing panel; pumping in heated air through any of the orifices; creating a vacuum by closing off all but one orifice and applying a vacuum to this orifice to draw the moisture out; inserting via one of the orifices desiccants to form a layer in the bottom of the panel to absorb the moisture within the panels (the desiccants can be vacuum out and may be left within the panels for instance 15 minutes to 24 hours or as required to adequately remove the moisture). These techniques may be useful in accelerating the egress of moisture and to ensure that a large quantity of moisture is evacuated prior to sealing.

It will be further appreciated, that the present invention decreases the pressure build up in windows exposed to a fire, thus preventing or decreasing their propensity to explode. Again, for this purpose, the orifice can be formed in any of the inside or outside panes, or in the spacer.

One embodiment of the invention provides a pre-installation method for obtaining an easy to treat glazing panel (e.g. a window) having a removable seal. The glazing panel has first and second panes and a spacer separating the panes. The method includes creating an orifice in both the first and second panes; installing a removable seal over the orifice in the first pane for sealing the same. The first pane may be an inside pane and the second pane may be an outside pane. The method may further comprise the steps of creating a second orifice in the first pane and installing a removable seal on the second orifice in the first pane. The method may further comprise the step of installing a valve on the second pane for reducing the amount of precipitation or matter from entering through the orifice in the second pane while allowing the passage of air. One embodiment of the invention provides the glazing panel so treated.

One embodiment of the invention provides a method for treating a glazing panel (e.g. a patio door) prior to installation for readying the glazing panel for further treatment. The glazing panel has a frame, first and second panes and a spacer separating the panes. The method comprising the steps of creating a channel in the frame for providing a passageway between the space between the panes and air outside of the glazing panel via a first opening in the frame; creating a second opening in the frame in communication with the channel; and applying a removable seal to the second opening. The method may further include the step of installing a valve to protect the first opening for reducing the amount of precipitation or matter from entering. The method may further comprise the step of inserting a desiccant in communication with the channel for absorbing moisture. The method may further comprise the step of creating a second distinct channel in the frame between the area between the panes and an inside location via a third opening, and applying a removable seal on the third opening. One embodiment of the invention provides a glazing panel so treated.

One embodiment of the invention provides the valve itself as described above and illustrated particularly in FIGS. 11 to 14.

When manufactured, glazing panels can be provided with Argon gas between the panes. Argon provides thermal insulation and sound dampening. Argon slowly leaks out of the panel. In one embodiment of the present invention, Argon is reintroduced. Other inert gases can be used, for instance, Krypton, however reference to Argon will be used hereafter for simplicity. An orifice is created in the pane, preferably in the top corner and Argon is introduced via a cylinder with a nozzle. The orifice is then sealed to seal in the Argon. In one embodiment, a self-sealing material is used to cover the orifice which allows the orifice to be penetrated by the gas nozzle and which, upon removal of the nozzle, seals again. Such materials are currently used in the medical field. As Argon is heavier than air, having the nozzle near the top of the pane allows for partial filling with Argon up to a desired point below the level of the orifice without losing the Argon. In another embodiment, the orifice is sealed with a glass plug slightly smaller than the orifice (for instance 2.95 mm diameter for a 3 mm diameter orifice) using an epoxy on the perimeter of the plug which hardens when exposed to UV rays. The insulating glass unit is now sealed.

The above-described embodiments of the present invention are intended to be examples only. Alterations, modifications and variations may be effected to the particular embodiments by those of skill in the art without departing from the scope of the invention, which is defined solely by the claims appended hereto.

1. A method of treating an installed glazing panel, the glazing panel having an inside pane, an outside pane and a spacer separating the panes, the method comprising the steps of:
creating from an inside location an inside orifice in the inside pane, and an outside orifice in the outside pane;
installing a valve on the outside pane for reducing the ingress of precipitation or matter between the inside and outside panes while allowing air including moisture in the air to exit from between the inside and outside panes; and
sealing the inside orifice.

2. The method according to claim 1, wherein the orifices are created adjacent an upper edge of the respective panes.

3. The method according to claim 1, wherein the outside orifice is created by accessing the outside pane through the inside orifice.

4. The method according to claim 1, wherein the valve is adhered to the outside pane.

5. The method according to claim 1, wherein the valve is friction fit within the outside orifice.

6. The method according to claim 1, wherein the orifices are created by a method selected from the group consisting of drilling, cutting, laser cutting, water cutting, and drill press drilling.

7. The method according to claim 1, wherein the inside orifice is sealed by a seal selected from the group consisting of a plug made of glass, polyethylene, polyester, polycarbonate, acrylic, Lexan™ or Mylar™, a disc made of glass, polyethylene, polyester, polycarbonate, acrylic, Lexan™ or Mylar™, and silicone.

8. The method according to claim 1, further comprising a step of, prior to sealing the inside orifice, applying a cleaning solution through the inside orifice and removing the cleaning solution thereby cleaning inside surfaces of the panes.

9. The method according to claim 8, further comprising a step of, prior to applying the cleaning solution, creating a drain orifice in the inside pane for draining cleaning solution or applying cleaning solution.

10. The method according to claim 9, wherein the drain orifice is created adjacent a bottom of the inside pane.

11. The method according to claim 1, further comprising the step of, prior to the sealing step, accelerating moisture egress by a technique selected from the group consisting of introducing an artificial light source to increase the temperature and thus the pressure within the glazing panel; pumping in heated air through any of the orifices; creating a vacuum by closing off all but one orifice and applying a vacuum to this orifice to draw moisture out; inserting via any one of the orifices, desiccants to absorb the moisture within the panels.

12. A method of treating a glazing panel having a frame, first and second panes forming a cavity, and a spacer separating the panes, the method comprising the steps of:
creating a vent orifice in a side of the frame the cavity and a location outside of the glazing panel passing through the spacer and inserting a vent tube in the vent orifice;
creating a breather orifice in the frame between a location outside of the glazing panel and intersecting with the vent orifice and inserting a breather tube in the breather orifice in communication with the vent tube;
applying a valve to the breather tube for reducing the amount of precipitation or matter from entering while allowing air including moisture in the air to exit from between the panes; and
sealing the vent orifice.

13. A method according to claim 12, further comprising the steps of:
creating a drain orifice in the frame distinct from the vent and breather orifices between the space between the panes and a location outside of the glazing panel passing through the spacer for draining liquid from between the panes; and
sealing the drain orifice.

14. The method according to claim 12, wherein the valve is adhered to the breather tube.

15. The method according to claim 12, wherein the valve is friction fit within the breather tube.

16. The method according to claim 12, wherein the vent orifice is sealed by a seal selected from the group consisting of a plug made of glass, polyethylene, polyester, polycarbonate, acrylic, Lexan™ or Mylar™, a disc made of glass, polyethylene, polyester, polycarbonate, acrylic. Lexan™ or Mylar™, and silicone.

17. The method according to claim 12, further comprising a step of, prior to sealing the vent orifice, applying a cleaning solution through the vent orifice and removing the cleaning solution for cleaning inside surfaces of the panes.

18. The method according to claim 12, wherein the vent orifice is created adjacent a top of the glazing panel.

19. The method according to claim 12, wherein the drain orifice is created adjacent a bottom of the glazing panel.

20. The method according to claim 12, further comprising the step of, prior to the sealing step, accelerating moisture egress by a technique selected from the group consisting of introducing an artificial light source to increase the temperature and thus the pressure within the glazing panel; pumping in heated air through any of the orifices; creating a vacuum by closing off all but one orifice and applying a vacuum to this orifice to draw moisture out; inserting via any one of the orifices, desiccants to absorb the moisture within the panels.

21. A method of treating a glazing panel for protecting the panel from breakage from pressure change caused by fire or elevation changes, the method comprising the steps of:
positioning the glazing panel for treatment; and
creating an orifice in a pane of the glazing panel.

22. A method according to claim 21, further comprising the step of installing a valve on the pane for reducing the amount of precipitation or matter from entering through the orifice in while allowing air including moisture in the air to exit the glazing panel.
